(19) United States
(12) Patent Application Publication
(10) Pub. No.: US 2015/0213515 A1
(43) Pub. Date: Jul. 30, 2015

(54) METHOD AND SYSTEM FOR ONLINE CONTENT MATCH ADVERTISING

(71) Applicant: YAHOO! INC., Sunnyvale,, CA (US)

(72) Inventor: Bruno M. Fernandez-Ruiz, London (GB)

(21) Appl. No.: 14/367,128

(22) PCT Filed: Jun. 17, 2013
(86) PCT No.: PCT/CN2013/000708

§ 371 Date: Jun. 19, 2014

(51) Int. Cl. G06Q 30/02

(52) U.S. Cl. CPC G06Q 30/0277; G06Q 30/0251

(57) ABSTRACT

Method, system, and programs for online content match advertising. In one example, one or more pieces of content are extracted from a stream of content. At least one topic is then determined. Each of the at least one topic is associated with one of the one or more pieces of content. One or more advertisements to be presented are determined based on the at least one topic. The one or more advertisements are presented in connection with a presentation of the one or more pieces of content. The one or more advertisements are presented in proximity to where the stream of content is presented.

### BACKGROUND

1. Technical Field

The present teaching relates to methods, systems, and programming for Internet service. Particularly, the present teaching relates to methods, systems, and programming for online advertising.

2. Discussion of Technical Background

Online advertising is a form of promotion that uses the Internet and World Wide Web to deliver marketing messages to attract customers. Examples of online advertising include contextual advertisements on search engine result pages, banner advertisements, blogs, rich media advertisements, interstitial advertisements, online classified advertising, advertising networks, and e-mail marketing. Many of these types of advertisements are delivered by an advertising serving mechanism such as an advertising server.

Content match advertising engages users when they are not actively searching, but are browsing content that may be related to certain brand, product or service. This offering enables advertisers to deliver contextually targeted advertisements by displaying them next to articles, product reviews and other content on a web page. However, known solutions for content match advertising are limited to static content, such as articles, product reviews, etc. For streams of content, such as a video clip or an animation, known solutions can only deliver advertisements based on the overall theme of the video, e.g., the title of the video, but cannot provide a serial of matched advertisements in a dynamic and real-time fashion based on the specific content in the stream. Moreover, the known video advertising schemes, e.g., pre-rolls video advertising, post-rolls video advertising, or overlays advertising, are more or less intrusive to the users who are watching the video as they interrupt the users' experience of watching the video.

Therefore, there is a need to provide an improved solution for online content match advertising to solve the above-mentioned problems.

### SUMMARY

The present teaching relates to methods, systems, and programming for Internet service. Particularly, the present teaching relates to methods, systems, and programming for online advertising.

In one example, a method, implemented on at least one machine each of which has at least one processor, storage, and a communication platform connected to a network for online advertising, is disclosed. One or more pieces of content are extracted from a stream of content. At least one topic is then determined. Each of the at least one topic is associated with one of the one or more pieces of content. One or more advertisements to be presented are determined based on the at least one topic. The one or more advertisements are presented in connection with a presentation of the one or more pieces of content. The one or more advertisements are presented in proximity to where the stream of content is presented.

In a different example, a system having at least one processor, storage, and a communication platform connected to a network for online advertising is disclosed. The system includes a content stream analyzing module, a content stream playing module, and an advertisement serving module. The content stream analyzing module is configured to extract one or more pieces of content from a stream of content and determine at least one topic, each of which is associated with one of the one or more pieces of content. The content stream playing module is configured to determine one or more advertisements to be presented based on the at least one topic. The advertisement serving module is configured to present the one or more advertisements in connection with a presentation of the one or more pieces of content. The one or more advertisements are presented in proximity to where the stream of content is presented.

Other concepts relate to software for online advertising. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for online advertising, wherein the information, when read by the machine, causes the machine to perform a series of steps. One or more pieces of content are extracted from a stream of content. At least one topic is then determined. Each of the at least one topic is associated with one of the one or more pieces of content. One or more advertisements to be presented are determined based on the at least one topic. The one or more advertisements are presented in connection with a presentation of the one or more pieces of content. The one or more advertisements are presented in proximity to where the stream of content is presented.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1-3 illustrate an exemplary web page having display advertisements that dynamically change based on the content of a content stream, according to an embodiment of the present teaching;

FIG. 4 is an exemplary functional block diagram of a system for online content match advertising, according to an embodiment of the present teaching;

FIG. 5 is a flowchart of an exemplary process for online content match advertising, according to an embodiment of the present teaching;

FIG. 6 is an exemplary functional block diagram of a content stream analyzing module in the system shown in FIG. 4, according to an embodiment of the present teaching;

FIG. 7 is a flowchart of an exemplary process for the content stream analyzing module shown in FIG. 6, according to an embodiment of the present teaching;

FIG. 8 is an exemplary functional block diagram of a content stream playing module in the system shown in FIG. 4, according to an embodiment of the present teaching;

FIG. 9 is a flowchart of an exemplary process for the content stream playing module shown in FIG. 8, according to an embodiment of the present teaching;

FIGS. 10-12 depict exemplary embodiments of a networked environment in which online content match advertising is applied, according to different embodiments of the present teaching;

FIG. 13 depicts a general mobile device architecture on which the present teaching can be implemented; and

FIG. 14 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of online content match advertising which changes and adapts to the content in a content stream as the stream plays. For example, the method and system disclosed herein enable the display advertisements to be changed in real-time based on the content of a video object being played and also contained on the same page, which is less intrusive compared with the known pre-rolls, post-rolls, or overlays video advertising. The advertisements delivered by the server may be related to the content shown on the current frame of the video, but shown on its own advertisement unit space. Additional novel features will be set forth in part in the description which follows, and in part will become apparent to those skilled in the art upon examination of the following and the accompanying drawings or may be learned by production or operation of the examples. The novel features of the present teaching may be realized and attained by practice or use of various aspects of the methodologies, instrumentalities and combinations set forth in the detailed examples discussed below.

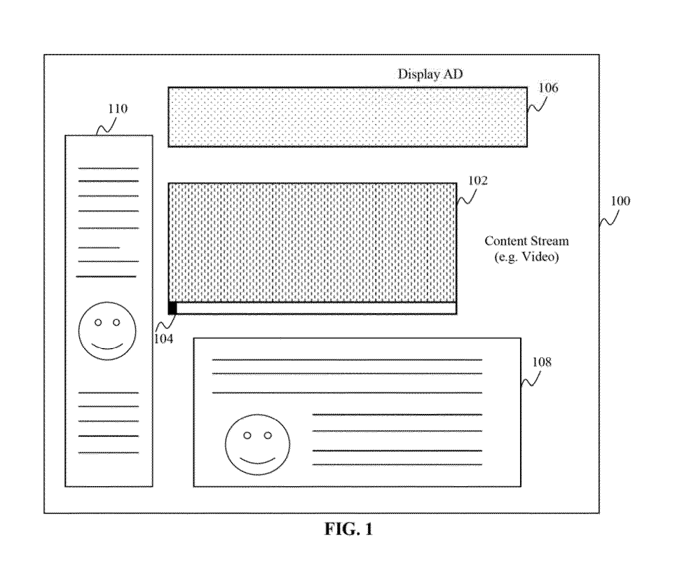

FIGS. 1-3 illustrate an exemplary web page having display advertisements that dynamically change based on the content of a content stream according to an embodiment of the present teaching. In FIG. 1, the web page 100 includes a content stream 102, such as a video clip, an animation, an audio, a stream of text, or a combination thereof. The content stream 102 may be divided into multiple portions that are presented in a fixed sequence. For example, a video stream includes a plurality of frames, each of which is displayed based on the timing thereof as the video plays. The timing of the content stream 102, e.g., relative position of each portion of the content stream, may be indicated and adjusted by a progress bar 104. One or more display advertisements 106 may be presented in proximity to where the content stream 102 is presented. That is, the content stream 102 and the display advertisements 106 are presented to users at different places on the same web page 100. Other content, such as reviews and comments 108 of the content stream 102 and background information 110 of the content stream 102, may also be included on the web page 100.

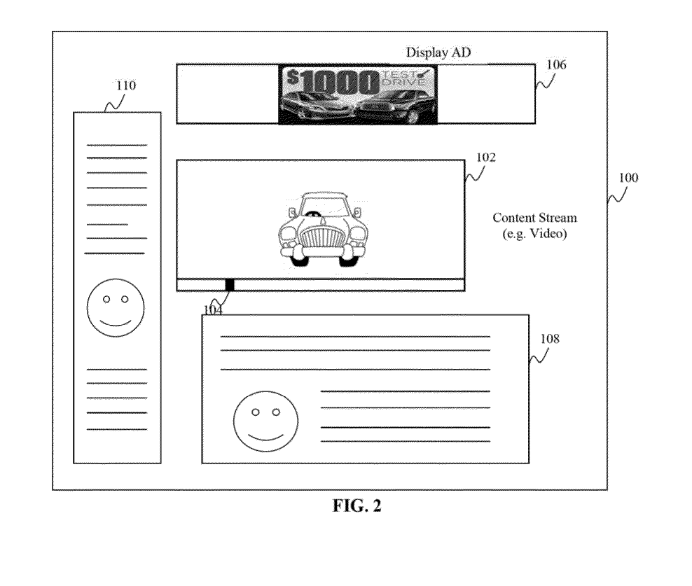

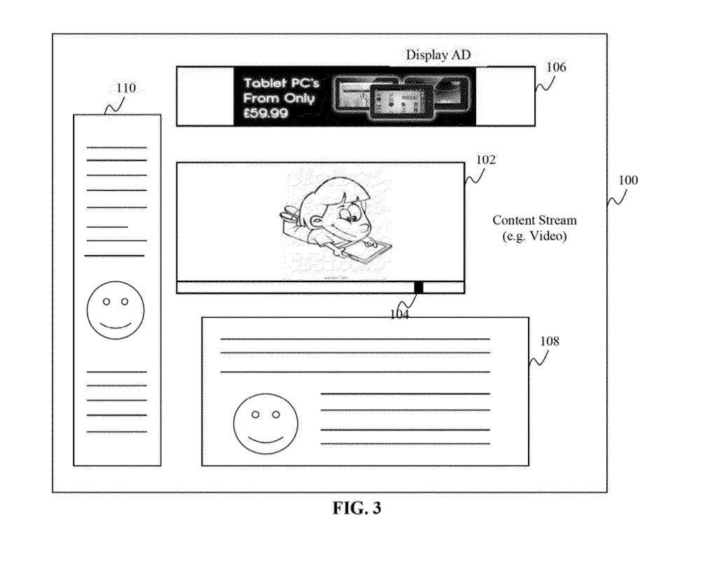

In this example, the display advertisements 106 dynamically change and adapt to the content in the content stream 102 as the content stream 102 plays. The presentations of the display advertisements 106 and the content stream 102 occur simultaneously. Accordingly, different from the pre-rolls or post-rolls video advertising, the presentation of the display advertisements 106 itself does not obstruct the play of the content stream 102 in this example. As shown in FIG. 2, a cartoon video clip is being played in this example. At certain point, a car is shown on one frame of the video clip, and the display advertisement 106 changes to a campaign of car sale accordingly. As the video plays, the display advertisement 106 may further change based on the content on the current video frame. In FIG. 3, the video progresses to a scene of a kid playing a tablet. Accordingly, the display advertisement 106 changes to a promotion of tablet PCs in real-time.

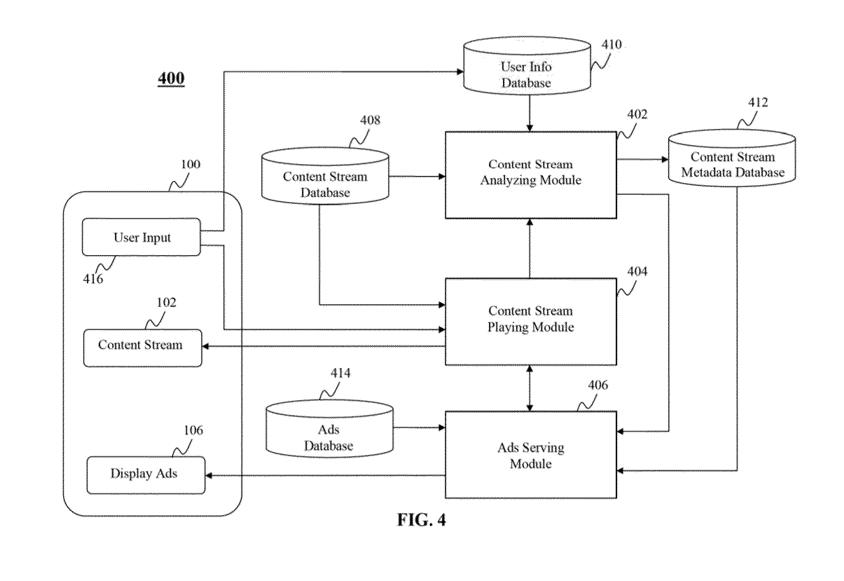

FIG. 4 is a high level exemplary system diagram of a system for online content match advertising, according to an embodiment of the present teaching. The system 400 in this example includes a content stream analyzing module 402, a content stream playing module 404, a advertisements serving module 406, and multiple databases, including a content stream database 408, a user information database 410, a content stream metadata database 412, and an advertisements database 414.

The content stream analyzing module 402 in this example is configured to ingest content streams, such as a video, from the content stream database 408 and store metadata extracted from the content streams including entities, topics and associated parameters (e.g., timing information) into the content stream metadata database 412. For example, the content stream analyzing module 402 may ingest a video stream and break the stream into significant video frame images with a time interval, e.g., every few seconds. The content stream analyzing module 402 may analyze each frame to identify entities appearing on the frame. These entities may be mapped to a universal interest space, e.g., topic taxonomy or a knowledge archive, in order for the content stream analyzing module 402 to determine one or more topics based on the identified entities, which may be used to fetch related advertisements. The content stream analyzing module 402 may further consider a particular user's interests when it determines the topics. For example, user information, such as user profiles, content consumed by the user, and user online activities, may be collected through the user input 416 on the web page 100 and stored into the user information database 410. The user's explicit and implicit interests may be determined by analyzing the collected user information using any suitable data mining and machine learning approaches as known in the art and provided to the content stream analyzing module 402. The user's interests may be taken into consideration in determining the relevant topics of the content stream. For example, different topics may be determined for a particular frame as multiple unrelated entities appear on that frame. In this case, if one of the topics matches one of the user's interests, then the topic may be considered as the most relevant topic for the purpose of fetching the advertisement accompanying the frame as the video plays.

The content stream playing module 404 in this example is configured to play the content stream 102 and determine one or more advertisements 106 to be presented based on the topics that have been determined for the content stream 102. In response to receiving a request to play a content stream, e.g., from the user input 416, the content stream playing module 404 may retrieve the requested content stream from the content stream database 408 and deliver the content stream to the user device such at the content stream 102 may be rendered and presented on the web page 100 at the user device. At the same time, the content stream playing module 404 may also retrieve the metadata previously extracted from the corresponding content stream by the content stream analyzing module 402. The content stream playing module 404 then may invoke a call to the advertisements serving module 406 every time there is a new topic or entity shown in the content stream, per the previously extracted and stored metadata. Based on the instruction from the content stream playing module 404, the advertisements serving module 406 is configured to fetch advertisements based on each topic and deliver the advertisements to the user device such that the corresponding advertisements 106 may be rendered and presented on the web page 100 at the user device as the content stream 102 plays.

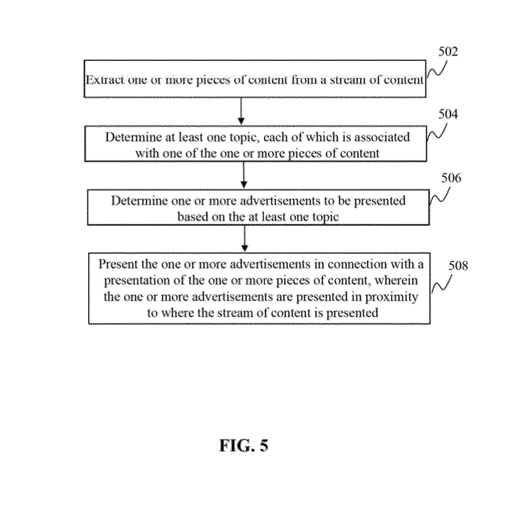

FIG. 5 is a flowchart of an exemplary process for online content match advertising, according to an embodiment of the present teaching. Starting from 502, one or more pieces of content are extracted from a stream of content. For example, one or more portions are extracted from the stream of content with a time interval. In one example, vide frame images may be extracted from a video stream every few seconds. Each of the one or more extracted portions is associated with a parameter indicating a timing of corresponding portion in the stream of content. Moving to 504, at least one topic is determined, each of which is associated with one of the one or more pieces of content. For example, an entity, e.g., an object, a person, or a scene, may be identified from any of the one or more portions using any suitable image recognition techniques known in the art. The entity may be mapped to a space representing universal interests, such as a topic taxonomy, a knowledge archive (e.g., Wikipedia, Encyclopedia), or a publisher-defined ontology. A topic then may be identified from the space representing universal interests based on the mapping. The identified topic is stored with the parameter indicating the timing of the portion in which the entity is identified. At 506, one or more advertisements to be presented are determined based on the at least one topic. For example, in response to a request to display the stream of content, at least one topic and the parameters indicating the timing of corresponding portions in the stream of content are retrieved. An advertisement is determined for each portion based on the corresponding topic identified for that portion. At 508, the one or more advertisements are presented in connection with a presentation of the one or more pieces of content. The one or more advertisements are presented in proximity to where the stream of content is presented. For example, the timing of presenting the one or more advertisements is determined based on the parameters indicating the timing of corresponding portions in the stream of content. Each of the one or more advertisements is presented when a corresponding portion is presented in the stream of content.

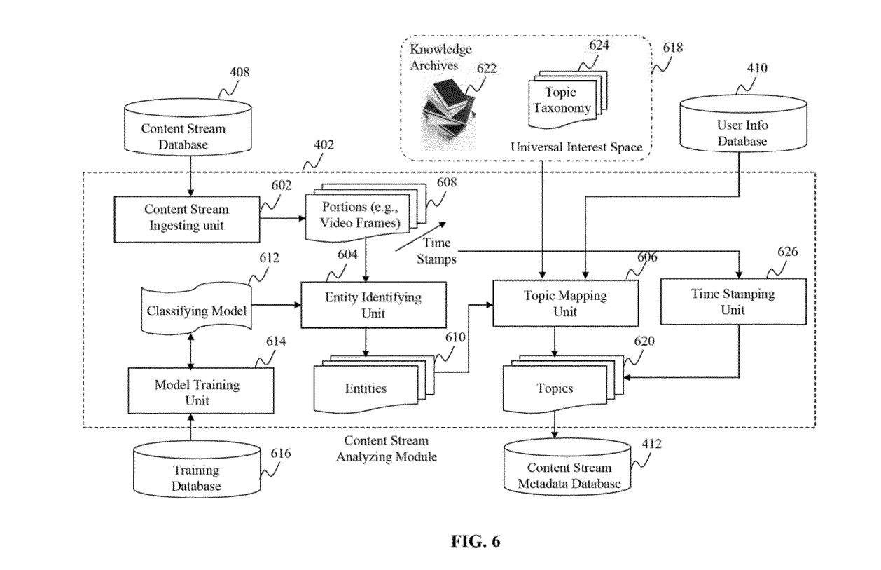

FIG. 6 is an exemplary functional block diagram of a content stream analyzing module in the system shown in FIG. 4, according to an embodiment of the present teaching. The content stream analyzing module 402 in this example includes a content stream ingesting unit 602, an entity identifying unit 604, and a topic mapping unit 606. The content stream ingesting unit 602 is configured to extract one or more portions 608 from the stream of content with a time interval. In one example, the content stream ingesting unit 602 ingests a video stream and breaks the stream into significant video frame images every few seconds. The time interval also determines the frequency of refreshing the display advertisements accompanying the content stream. Each of the one or more portions 608 is associated with a parameter indicating a timing (relative position) of corresponding portion in the stream of content. For example, the parameter may be a time stamp for each extracted frame in a video frame.

The entity identifying unit 604 in this example is configured to identify an entity 610 from any of the one or more portions 608. The entity 610 may be, for example, an object, a person, a scene, or an abstract concept. In one example, the entity identifying unit 604 may be an image recognition classifier trained to identify entities 610. In this example, a classifying model 612 may be trained by a model training unit 614 using training dataset stored in a training database 616. The training may be performed by any suitable machine learning techniques known in the art. It is understood that, any other image recognition techniques may be used to identify entities 610 from video frames or other images. For other types of content stream, different approaches may be used to implement the entity identifying unit 604. In one example, lexical semantic analysis (LSA) may be used to identify entities 610 from text. In another example, voice recognition techniques may be used to translate audio content into text, and LSA may be used to identify entities 610 from the translated text.

The topic mapping unit 606 in this example is configured to map the entity 610 to a space representing universal interests 618, and identify a topic 620 from the space representing universal interests 618. The universal interests space 618 may be any suitable sources providing general interest representation, including online knowledge archives 622 such as Wikipedia, Merriam-Webster Online, Oxford Dictionaries Online, and Dictionary.com, etc. Each of such archives provides information related to various interests/topics. For example, Wikipedia provides various fine level interest descriptions, including football, peach, Mitt Romney, Barack Obama, Michael Jordan, election, etc. Another type of general representation of interests is at topic taxonomy level which is directed to a broad category level interest/topic representation. The topic taxonomy 624 may be organized as a hierarchical structure of different levels. For example, content may be classified into politics, health, sports, entertainment, . . . , finance, and laws. Each of such categories may include sub categories. For instance, entertainment may include movies and music, while movies may include comedy, romance, and drama and music may include jazz, country and rock music. Although they may represent interests at different levels, such general interest representations may be leveraged to develop a universal interest space in which user interests/topics may be represented in a uniform manner. Details of identifying interests/topics based on mapping to a universal interests space are disclosed, for example, in the co-pending U.S. patent application Ser. No. 13/837,357, titled “Method and System For User Profiling Via Mapping Third Party Interests To A Universal Interest Space,” filed on Mar. 15, 2013.

The content stream analyzing module 402 in this example may also include a time stamping unit 626 configured to associate the identified topics 620 with the parameter indicating the timing of the portion in which the entity is identified, e.g., time stamps. The identified topics 620 are then stored with the parameters indicating the timing of the portion in which the entity is identified in the content stream metadata database 412 as metadata for each particular content stream. The metadata is indexed based on the corresponding content stream from which the metadata is extracted.

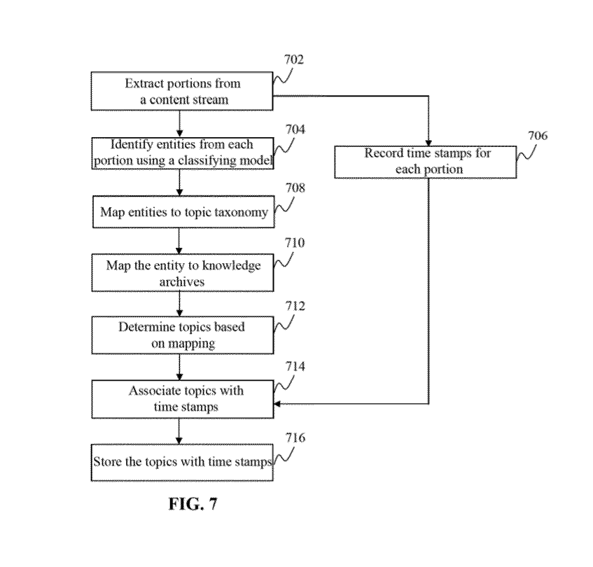

FIG. 7 is a flowchart of an exemplary process for the content stream analyzing module shown in FIG. 6, according to an embodiment of the present teaching. Beginning at 702, a content stream is divided into portions, some of which are extracted for analysis with a preset time interval. At 704, entities are identified from each portion in the content stream using a classifying model. At 706, the time stamps indicating the timing of each portion in the content stream are recorded. The identified entities then are mapped to a topic taxonomy at 708 and/or a knowledge archive at 710, and one or more topics are determined based on the mapping at 712. Moving to 714, the determined topics are associated with the corresponding time stamps. At 716, the topics and their associated time stamps are stored as metadata of the particular content stream for future use.

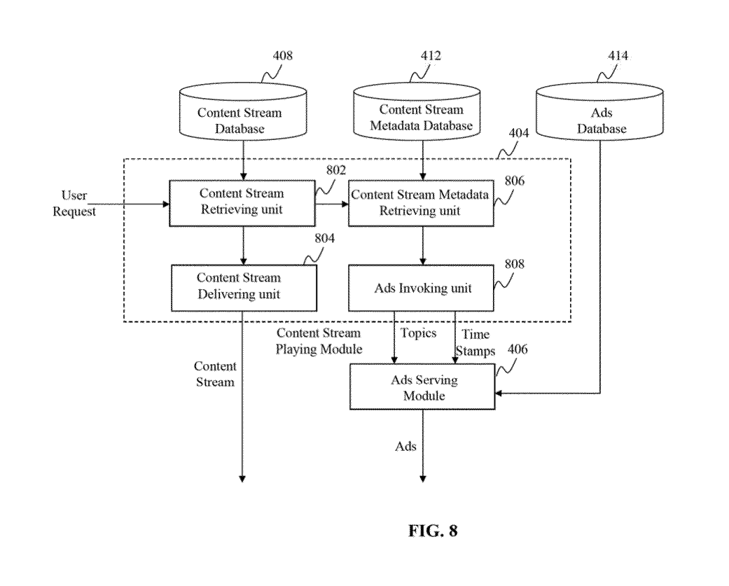

FIG. 8 is an exemplary functional block diagram of a content stream playing module in the system shown in FIG. 4, according to an embodiment of the present teaching. The content stream playing module 404 in this example includes a content stream retrieving unit 802 configured to retrieve content streams from the content stream database 408 in response to user requests. The retrieved content streams are delivered to the user device by a content stream delivering unit 804.

The content stream playing module 404 in this example also includes a content stream metadata retrieving unit 806 and an advertisements invoking unit 808. The content stream metadata retrieving unit 806 is configured to retrieve, in response to the user request to display the stream of content, at least one topic and the parameters indicating the timing of corresponding portions in the stream of content. That is, once the user request is received, the content stream metadata retrieving unit 806 retrieves the corresponding metadata including the previously extracted topics and associated timing information thereof from the content stream metadata base 412. The advertisement invoking unit 808 is configured to determine an advertisement for each portion based on the corresponding topic identified for that portion. For example, the advertisement invoking unit 808 sends the topics and their associated time stamps to the advertisements serving module 406 such that the advertisements servicing module 406 is able to retrieve advertisements related to each topic from the advertisements database 414 and deliver the advertisements to the user device at the appropriate time based on the timing information. In one example, the advertisements servicing module 406 determines the timing of presenting the one or more advertisements based on the parameters indicating the timing of corresponding portions in the stream of content and presents each of the one or more advertisements when a corresponding portion is presented in the stream of content.

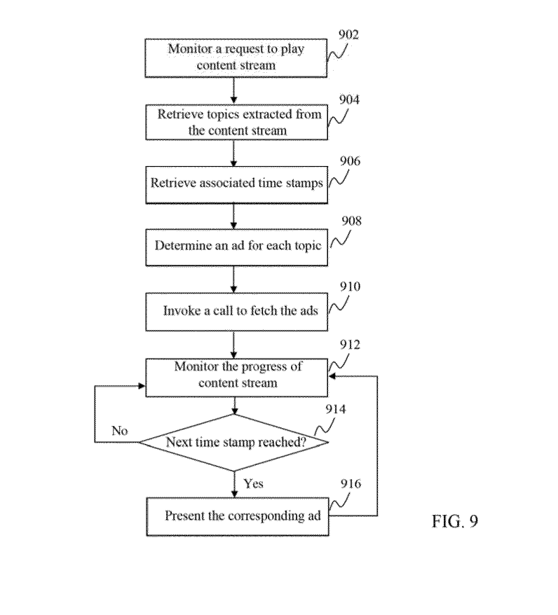

FIG. 9 is a flowchart of an exemplary process for the content stream playing module shown in FIG. 8, according to an embodiment of the present teaching. Beginning at 902, user requests to play content streams are monitored. Once a user request to play a particular content stream is identified, topics previously extracted from the content stream are retrieved at 904, and the associated time stamps of the topics are retrieved at 906. Advertisements are determined for each retrieved topic at 908. Moving to 910, a call to fetch the determined advertisements is invoked. The progress of the content stream is monitored at 912. At 914, whether the content stream reaches the next retrieved time stamp is determined. If the next time stamp is reached, i.e., a new topic is shown in the content stream, the corresponding advertisement is presented at 916. Otherwise, the process returns to 912 to continue monitoring the progress of the content stream.

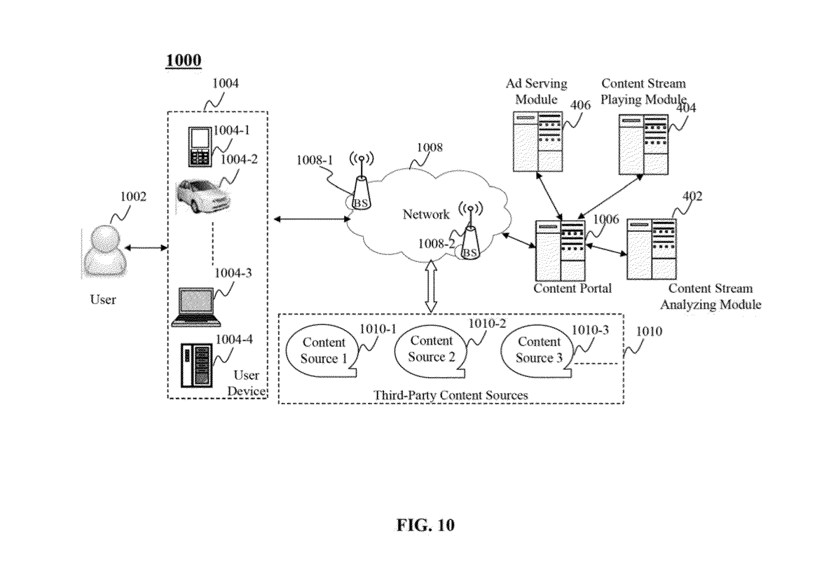

FIGS. 10-12 depict exemplary embodiments of a networked environment in which online content match advertising is applied, according to different embodiments of the present teaching. In FIG. 10, an exemplary networked environment 1000 includes the content stream analyzing module 402, the content stream playing module 404, the advertisements serving module 406, users 1002, the user devices 1004, a content portal 1006, a network 1008, and third-party content sources 1010. The network 1008 may be a single network or a combination of different networks. For example, the network 1008 may be a local area network (LAN), a wide area network (WAN), a public network, a private network, a proprietary network, a Public Telephone Switched Network (PSTN), the Internet, a wireless network, a virtual network, or any combination thereof. The network 1008 may also include various network access points, e.g., wired or wireless access points such as base stations or Internet exchange points 1008-1, . . . , 1008-2, through which a data source may connect to the network 1008 in order to transmit information via the network 1008.

Users 1002 may be of different types such as users connected to the network 1008 via different user devices 1004, for example, a desktop computer 1004-4, a laptop computer 1004-3, a mobile device 1004-1, or a built-in device in a motor vehicle 1004-2. A user 1002 may use the user device 1004 to send a request and provide user information to the content portal 1006 (e.g., a search engine, a social media website, etc.) via the network 1008 and receive content streams and display advertisements from the content portal 1006 through the network 1008. The content stream analyzing module 402, content stream playing module 404, and advertisements serving module 406 in this example may work as backend support for the content portal 1006 to provide content match online advertising service for the user 1002. In this example, content steams and/or display advertisements may also be retrieved from third-party content sources 1010-1, 1010-2, 1010-3. A third-party content source 1010 may correspond to a website hosted by an entity, whether an individual, a business, or an organization such as USPTO.gov, a content provider such as cnn.com and facebook.com, or a content feed source such as Twitter or blogs.

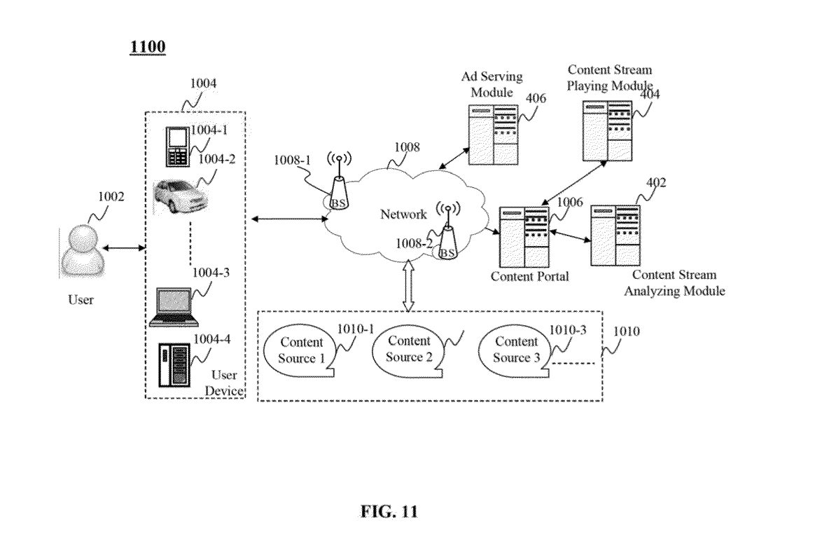

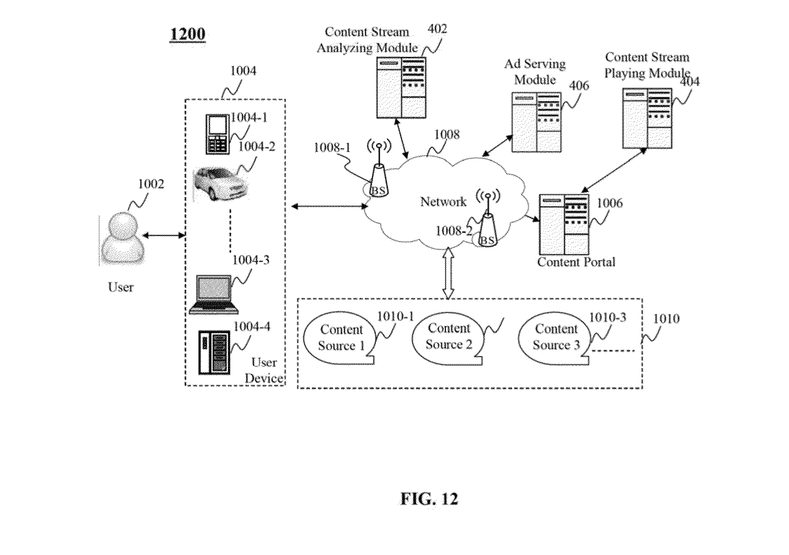

FIG. 11 presents a similarly networked environment 1100 as what is shown in FIG. 10 except that the advertisements serving module 406 is configured as an independent service provider that independently provides advertising service. FIG. 12 presents a similarly networked environment 1200 as what is shown in FIG. 11 except that the content stream analyzing module 402 is configured as an independent service provider that independently provides content stream analyzing service.

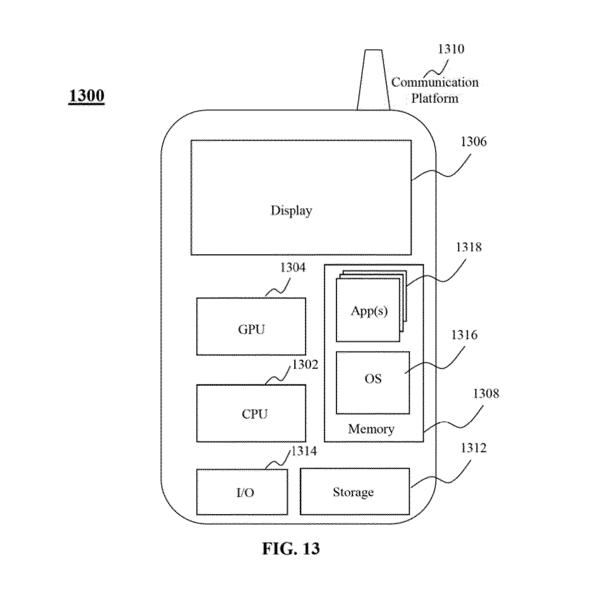

FIG. 13 depicts a general mobile device architecture on which the present teaching can be implemented. In this example, the user device on which online content match advertising is performed is a mobile device 1300, including but is not limited to, a smart phone, a tablet, a music player, a handled gaming console, a global positioning system (GPS) receiver. The mobile device 1300 in this example includes one or more central processing units (CPUs) 1302, one or more graphic processing units (GPUs) 1304, a display 1306, a memory 1308, a communication platform 1310, such as a wireless communication module, storage 1312, and one or more input/output (I/O) devices 1314. Any other suitable component, such as but not limited to a system bus or a controller (not shown), may also be included in the mobile device 1300. As shown in FIG. 13, a mobile operating system 1316, e.g., iOS, Android, Windows Phone, etc., and one or more applications 1318 may be loaded into the memory 1308 from the storage 1312 in order to be executed by the CPU 1302. The applications 1318 may include a browser or any other suitable mobile apps for receiving and rendering web pages having streams of content, e.g., video, and display advertisements on the mobile device 1300. Execution of the applications 1318 may cause the mobile device 1300 to perform the processing as described above. For example, the display of streams of content, e.g., video, and advertisements to the user may be made by the GPU 1304 in conjunction with the display 1306. User interactions with the web pages may be achieved via the I/O devices 1314 and sent to the remote servers via the communication platform 1310.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

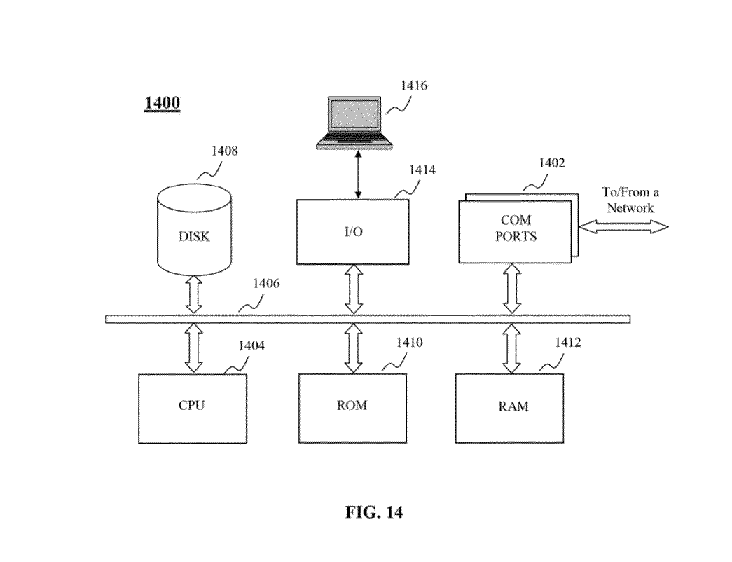

FIG. 14 depicts a general computer architecture on which the present teaching can be implemented and has a functional block diagram illustration of a computer hardware platform that includes user interface elements. The computer may be a general-purpose computer or a special purpose computer. This computer 1400 can be used to implement any components of the online content match advertising architecture as described herein. Different components of the system in the present teaching can all be implemented on one or more computers such as computer 1400, via its hardware, software program, firmware, or a combination thereof. Although only one such computer is shown, for convenience, the computer functions relating to the dynamic content pre-caching may be implemented in a distributed fashion on a number of similar platforms, to distribute the processing load.

The computer 1400, for example, includes COM ports 1402 connected to and from a network connected thereto to facilitate data communications. The computer 1400 also includes a central processing unit (CPU) 1404, in the form of one or more processors, for executing program instructions. The exemplary computer platform includes an internal communication bus 1406, program storage and data storage of different forms, e.g., disk 1408, read only memory (ROM) 1410, or random access memory (RAM) 1412, for various data files to be processed and/or communicated by the computer, as well as possibly program instructions to be executed by the CPU. The computer 1400 also includes an I/O component 1414, supporting input/output flows between the computer and other components therein such as user interface elements 1416. The computer 1400 may also receive programming and data via network communications.

Hence, aspects of the method of online content match advertising, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution. In addition, the components of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine, each of which has at least one processor, storage, and a communication platform connected to a network for online advertising, comprising the steps of:
extracting, by a content stream analyzing module, one or more pieces of content from a stream of content;
determining, by the content stream analyzing module, at least one topic, each of which is associated with one of the one or more pieces of content;
determining, by a content stream playing module, one or more advertisements to be presented based on the at least one topic; and
presenting, by an advertisement serving module, the one or more advertisements in connection with a presentation of the one or more pieces of content, wherein the one or more advertisements are presented in proximity to where the stream of content is presented.

2. The method of claim 1, wherein the stream of content includes a video, an animation, an audio, a stream of text, or a combination thereof

3. The method of claim 1, wherein the step of extracting one or more pieces of content comprise:
extracting one or more portions from the stream of content with a time interval, wherein each of the one or more portions is associated with a parameter indicating a timing of corresponding portion in the stream of content.

4. The method of claim 3, wherein the step of determining at least one topic comprises:
identifying an entity from any of the one or more portions;
mapping the entity to a space representing universal interests; and
identifying a topic from the space representing universal interests, wherein the identified topic is stored with the parameter indicating the timing of the portion in which the entity is identified.

5. The method of claim 4, wherein the step of determining one or more advertisements comprise:
retrieving, in response to a request to display the stream of content, at least one topic and the parameters indicating the timing of corresponding portions in the stream of content; and
determining an advertisement for each portion based on the corresponding topic identified for that portion.

6. The method of claim 5, wherein the step of presenting the one or more advertisements comprises:
determining the timing of presenting the one or more advertisements based on the parameters indicating the timing of corresponding portions in the stream of content; and
presenting each of the one or more advertisements when a corresponding portion is presented in the stream of content.

7. The method of claim 1, wherein the one or more advertisements and the stream of content are presented in difference places on a web page.

8. A system having at least one processor, storage, and a communication platform connected to a network for online advertising, comprising:
a content stream analyzing module configured to
extract one or more pieces of content from a stream of content, and
determine at least one topic, each of which is associated with one of the one or more pieces of content; and
a content stream playing module configured to determining one or more advertisements to be presented based on the at least one topic; and
an advertisement serving module configured to present the one or more advertisements in connection with a presentation of the one or more pieces of content, wherein the one or more advertisements are presented in proximity to where the stream of content is presented.

9. The system of claim 8, wherein the stream of content includes a video, an animation, an audio, a stream of text, or a combination thereof.

10. The system of claim 8, wherein the content stream analyzing module comprise a content stream ingesting unit configured to extract one or more portions from the stream of content with a time interval; and
wherein each of the one or more portions is associated with a parameter indicating a timing of corresponding portion in the stream of content.

11. The system of claim 10, wherein the content stream analyzing module further comprises:
an entity identifying unit configured to identify an entity from any of the one or more portions, and
a topic mapping unit configured to map the entity to a space representing universal interests, and identify a topic from the space representing universal interests; and
wherein the identified topic is stored with the parameter indicating the timing of the portion in which the entity is identified.

12. The system of claim 11, wherein the content stream playing module comprise:
a content stream metadata retrieving unit configured to retrieve, in response to a request to display the stream of content, at least one topic and the parameters indicating the timing of corresponding portions in the stream of content; and
an advertisement invoking unit configured to determine an advertisement for each portion based on the corresponding topic identified for that portion.

13. The system of claim 12, wherein the advertisement serving module is further configured to:
determine the timing of presenting the one or more advertisements based on the parameters indicating the timing of corresponding portions in the stream of content; and
present each of the one or more advertisements when a corresponding portion is presented in the stream of content.

14. The system of claim 8, wherein the one or more advertisements and the stream of content are presented in difference places on a web page.

15. A machine-readable tangible and non-transitory medium having information for online advertising recorded thereon, wherein the information, when read by the machine, causes the machine to perform the following:
extracting one or more pieces of content from a stream of content;
determining at least one topic, each of which is associated with one of the one or more pieces of content;
determining one or more advertisements to be presented based on the at least one topic; and
presenting the one or more advertisements in connection with a presentation of the one or more pieces of content, wherein the one or more advertisements are presented in proximity to where the stream of content is presented.

16. The medium of claim 15, wherein the stream of content includes a video, an animation, an audio, a stream of text, or a combination thereof

17. The medium of claim 15, wherein the step of extracting one or more pieces of content comprise:
extracting one or more portions from the stream of content with a time interval, wherein each of the one or more portions is associated with a parameter indicating a timing of corresponding portion in the stream of content.

18. The medium of claim 17, wherein the step of determining at least one topic comprises:
identifying an entity from any of the one or more portions;
mapping the entity to a space representing universal interests; and
identifying a topic from the space representing universal interests, wherein the identified topic is stored with the parameter indicating the timing of the portion in which the entity is identified.

19. The medium of claim 18, wherein the step of determining one or more advertisements comprise:
retrieving, in response to a request to display the stream of content, at least one topic and the parameters indicating the timing of corresponding portions in the stream of content; and
determining an advertisement for each portion based on the corresponding topic identified for that portion.

20. The medium of claim 19, wherein the step of presenting the one or more advertisements comprises:
determining the timing of presenting the one or more advertisements based on the parameters indicating the timing of corresponding portions in the stream of content; and
presenting each of the one or more advertisements when a corresponding portion is presented in the stream of content.
